(19) United States
(12) Patent Application Publication
(10) Pub. No.: US 2025/0350741 A1
(43) Pub. Date: Nov. 13, 2025

(54) REFERENCE FRAME PROCESSING METHOD AND APPARATUS BASED ON VERSATILE VIDEO CODING, COMPUTER DEVICE AND STORAGE MEDIUM

(71) Applicant: SHANGHAI BILIBILI TECHNOLOGY CO., LTD., Shanghai (CN)

(72) Inventor: Kaiyue SHI, Shanghai (CN)

(21) Appl. No.: 19/196,674

(22) Filed: May 1, 2025

(30) Foreign Application Priority Data
May 8, 2024 (CN) 202410566266.6

(51) Int. Cl. H04N 19/147; H04N 19/109; H04N 19/139; H04N 19/172; H04N 19/184; H04N 19/52

(52) U.S. Cl. CPC H04N 19/147; H04N 19/109; H04N 19/139; H04N 19/172; H04N 19/184; H04N 19/52

(57) ABSTRACT

The application provide a reference frame processing method based on versatile video coding, including: determining a current best rate-distortion cost based on a first rate-distortion cost and a second rate-distortion cost during inter prediction; and sequentially performing a unidirectional prediction in two directions, and sequentially traversing several neighboring reference frames in time domain when performing a unidirectional prediction in one direction, and performing the following steps during each reference frame traversal: constructing a prediction motion vector list, and determining an actual motion vector and a motion vector difference of a current reference frame; determining a minimum rate-distortion cost of the current reference frame, and determining a quantity of bits required for coding the motion vector difference; and terminating traversal of the reference frame when a traversal of the current reference frame is completed, and the minimum rate-distortion cost and the quantity of bits meet a preset condition.

### CROSS-REFERENCE TO RELATED APPLICATION

This application claims priority to Chinese Patent Application No. 202410566266.6 filed on May 8, 2024, which is incorporated herein by reference in its entirety.

### TECHNICAL FIELD

The application relates to the field of video technologies, and in particular, a reference frame processing method and apparatus based on versatile video coding, a computer device, and a storage medium.

### BACKGROUND

Versatile video coding (VVC) is the latest coding standard released in 2020. Like a conventional coding standard, the VCC adopts a block-based hybrid coding framework and is divided into different modules such as intra prediction, inter prediction, transformation, quantization, and entropy coding. A purpose of the inter prediction is to remove time redundancy of a video, and taking the information of a coded frames as a reference frame to predict a current frame can achieve the purpose.

A whole inter prediction may be divided into four modes: skip, merge, unidirectional prediction, and bidirectional prediction. The skip mode and merge mode are relatively simple modes, a reference frame does not need to be searched to construct motion vector (MV) information, and an MV of a spatially adjacent block or an MV of a temporally adjacent collocated block is directly used. The unidirectional prediction and the bidirectional prediction are relatively complex modes that require constructing a prediction motion vector (MPV) list for the reference frame and performing a search to obtain a final MV. Currently, the VVC standard specifies that there can be up to 15 reference frames, only one reference frame can be used for the unidirectional prediction, and two reference frames can be used for the bidirectional prediction. An encoder selects a best reference frame based on a rate-distortion theory. For unidirectional prediction, the encoder traverses all reference frames one by one and searches corresponding MVs, and then selects a reference frame with a lowest cost as the best reference frame based on a rate-distortion cost. For bidirectional prediction, all combinations of reference frames are also traversed, and a reference frame combination with a minimum cost is selected based on the rate-distortion cost.

In an actual coding process, if the foregoing traversal and search are performed on all coding units during inter prediction, the calculation amount is very large, therefore, some algorithms exist in the encoder to prune the reference frame. However, current algorithms can prune only a reference frame for bidirectional prediction, but cannot prune a reference frame for unidirectional prediction.

### SUMMARY

The application is intended to provide a reference frame processing method and apparatus based on versatile video coding, a computer device, and a storage medium, to solve the following technical problem that algorithms in related technologies can prune only a reference frame for a bidirectional prediction, but cannot prune a reference frame for a unidirectional prediction.

One aspect of embodiments of the application provides a reference frame processing method based on versatile video coding, including: when an inter prediction of a current coding unit is performed, obtaining a first rate-distortion cost in a skip mode and a second rate-distortion cost in a merge mode, and determining a current best rate-distortion cost based on the first rate-distortion cost and the second rate-distortion cost; and sequentially performing unidirectional prediction in two directions, and traversing several neighboring reference frames in time domain sequentially when a unidirectional prediction in one direction is performed, wherein the following steps are performed during each reference frame traversal: constructing a prediction motion vector list, and determining an actual motion vector and a motion vector difference of a current reference frame by searching the prediction motion vector list, wherein the motion vector difference is a difference between a prediction motion vector and the actual motion vector; determining a minimum rate-distortion cost of the current reference frame, and determining a quantity of bits required for coding the motion vector difference; and terminating traversal of the reference frame and performing unidirectional prediction in a next direction or ending unidirectional prediction when a traversal of the current reference frame is completed and the minimum rate-distortion cost and the quantity of bits meet a preset condition.

Optionally, the method further includes: proceeding to a traversal of a next reference frame when the traversal of the current reference frame is completed and the minimum rate-distortion cost and the quantity of bits do not meet the preset condition.

Optionally, the preset condition includes: the minimum rate-distortion cost is greater than N times the current best rate-distortion cost, and the current best rate-distortion cost is greater than M times a product of the quantity of bits and a Lagrange multiplier used by the current coding unit, wherein N and M are greater than 1.

Optionally, the method further includes: determining a motion complexity of the current coding unit; and determining a value of N based on the motion complexity.

Optionally, the method further includes: determining a prediction residual of the current coding unit when a rate-distortion cost is calculated; and calculating the rate-distortion cost based on the prediction residual, the quantity of bits, and a Lagrange multiplier of the current coding unit.

One aspect of the embodiments of the application further provides a reference frame processing apparatus based on versatile video coding, including: a determining module, configured to: when an inter prediction of a current coding unit is performed, obtain a first rate-distortion cost in a skip mode and a second rate-distortion cost in a merge mode, and determine a current best rate-distortion cost based on the first rate-distortion cost and the second rate-distortion cost; and a unidirectional prediction module, configured to sequentially perform unidirectional prediction in two directions, and traverse several neighboring reference frames in time domain sequentially when a unidirectional prediction in one direction is performed, wherein the following steps are performed during each reference frame traversal: constructing a prediction motion vector list, and determining an actual motion vector and a motion vector difference of a current reference frame by searching the prediction motion vector list, wherein the motion vector difference is a difference between a prediction motion vector and the actual motion vector; determining a minimum rate-distortion cost of the current reference frame, and determining a quantity of bits required for coding the motion vector difference; and terminating traversal of the reference frame and performing unidirectional prediction in a next direction or ending unidirectional prediction when a traversal of the current reference frame is completed and the minimum rate-distortion cost and the quantity of bits meet a preset condition.

Optionally, the unidirectional prediction module is further configured to: proceeding to a traversal of a next reference frame when traversal of the current reference frame is completed and the minimum rate-distortion cost and the quantity of bits do not meet the preset condition.

Optionally, the preset condition includes: the minimum rate-distortion cost is greater than N times the current best rate-distortion cost, and the current best rate-distortion cost is greater than M times a product of the quantity of bits and a Lagrange multiplier used by the current coding unit, wherein N and M are greater than 1.

One aspect of the embodiments of the application further provides a computer device including a memory, a processor, and a computer program that is stored in the memory and capable of running on the processor, Wherein the processor implements steps of the reference frame processing method based on versatile video coding when executing the computer program.

One aspect of the embodiments of the application further provides a computer-readable storage medium, wherein the computer-readable storage medium stores a computer program, and the computer program is executable by at least one processor, so that the at least one processor performs the steps of the foregoing reference frame processing method based on versatile video coding.

The reference frame processing method and apparatus based on versatile video coding, the computer device, and the storage medium according to the embodiments of the application include the following advantages:

During the inter prediction, firstly, the current best rate-distortion cost is determined based on rate-distortion costs corresponding to the skip mode and the merge mode, and then the unidirectional prediction in two directions is sequentially performed. During the unidirectional prediction, neighboring reference frames in time domain are sequentially traversed. During the traversal of the reference frame, the prediction motion vector list is constructed. The minimum rate-distortion cost of the current reference frame and the quantity of bits required for coding the motion vector difference are determined based on the prediction motion vector list. When the traversal of the current reference frame is completed, and the minimum rate-distortion cost of the current reference frame and the quantity of bits required for coding the motion vector difference meet the preset condition, the traversal of the reference frame is terminated, and the unidirectional prediction in the next direction is performed or the unidirectional prediction is ended. Pruning of the remaining reference frame to be traversed can be implemented, thereby implementing pruning of the reference frame for the unidirectional prediction, reducing calculation amount during coding, and increasing the coding speed.

### BRIEF DESCRIPTION OF DRAWINGS

FIG. 1 is a schematic flowchart of a reference frame processing method based on versatile video coding according to Embodiment 1 of the application;

FIG. 2 is a flowchart of new steps in FIG. 1;

FIG. 3 is another flowchart of new steps in FIG. 1;

FIG. 4 is a schematic flowchart of a reference frame processing method based on versatile video coding according to Embodiment 1 of the application;

FIG. 5 is a schematic block diagram of a reference frame processing apparatus based on versatile video coding according to Embodiment 2 of the application; and

FIG. 6 is a schematic diagram of a hardware architecture of a computer device according to Embodiment 3 of the application.

### DESCRIPTION OF EMBODIMENTS

To make the objectives, technical solutions, and advantages of the application clearer and more comprehensible, the following further describes the application in detail with reference to the accompanying drawings and embodiments. It should be understood that the specific embodiments described herein are merely used to explain the application but are not intended to limit the application. All other embodiments obtained by a person of ordinary skill in the art based on the embodiments of the application without creative efforts shall fall within the protection scope of the application.

It should be noted that the descriptions such as “first” and “second” in the embodiments of the application are merely used for description, and shall not be understood as an indication or implication of relative importance or an implicit indication of a quantity of indicated technical features. Therefore, a feature defined with “first” or “second” may explicitly or implicitly include at least one feature. In addition, the technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

In the descriptions of the application, it should be understood that numerical symbols before steps do not indicate an order of performing the steps, but are merely used to facilitate description of the application and differentiation of each step, and therefore cannot be construed as a limitation on the application.

The following explains terms in this application:

Versatile video coding (VVC), it is also referred to as H.266, MPEG-I Part 3, or future video coding, is a video compression standard finally determined by the Joint Video Experts Group on Jul. 6, 2020, and is a successor standard of High Efficiency Video Coding (HEVC).

Coding unit (CU), it is an important concept in video coding, and is a basic processing unit of a video frame in a compression coding process. The CU has a feature that the CU exists in a block form, and a size of the CU may range from 4×4 to maximum 128×128 (LCU, that is, Largest Coding Unit). A large CU is typically suitable for a relatively smooth part of an image, while a small CU is suitable for an edge and an area with rich textures. The CU is a basic unit of prediction coding, and a series of processes such as prediction, transformation, quantization, and entropy coding are performed in a coding process. These processes help to compress video data more effectively while maintaining video quality as much as possible.

Motion vector, in video coding, it refers to a relative displacement of a block to be predicted relative to a size block of the same size in a reference frame, and is used to describe a motion status of an object or an area in an image. The description may help an encoder to compress video data more effectively, as by understanding the motion status of the object, the encoder can predict and code a future frame more effectively.

Motion vector prediction (MVP), it is mainly used to predict a motion status of a current block or image based on motion vector information in a neighboring block or an earlier coded image. The MVP is intended to reduce a quantity of bits coded by a motion vector related part and further reduce a volume of compressed data. By comparing the motion vector prediction with an actual motion vector and coding only a difference (that is, an MVD) between the motion vector prediction and the actual motion vector, more efficient data compression can be implemented.

Actual motion vector, in video coding and image processing, it refers to a vector that describes an actual displacement of an object or an image block between consecutive frames. The vector includes information about a direction and a size of an object or an image block from one position to another. In a video coding process, the encoder attempts to find, by analyzing image content of consecutive frames, a correspondence between objects or image blocks in neighboring frames. The correspondence is determined by calculating the actual motion vector. Motion vector coding is a key part of video compression, and helps the encoder transmit only changed information in a subsequent frame, rather than complete image data, thereby implementing efficient data compression. The actual motion vector is obtained through calculation in a motion estimation process. A motion estimation is a search process, and the encoder searches a reference frame for a block that mostly matches an image block in a current frame, and then calculates a displacement between the two blocks to obtain the actual motion vector. The vector includes not only a horizontal displacement but also a vertical displacement, and therefore it is a two-dimensional vector.

Rate-distortion cost (RDC), it is a key indicator used to measure coding efficiency in video coding. A coded rate and distortion are combined therein to find an equilibrium point, so that the distortion is minimized at a given rate limit or the rate is minimized at a given distortion tolerance.

Reference frame, it is a key concept in video coding. The reference frame is mainly used in an inter-frame compression technology to code a current frame by referring to information about another frame, thereby improving coding efficiency. During coding, some types of frames (such as a P frame and a B frame) will refer to other frames to generate their own coded data. These referenced frames are reference frames.

In related technologies, only a reference frame for bidirectional prediction can be pruned, but a reference frame for unidirectional prediction cannot be pruned.

A reference frame processing method based on versatile video coding according to the embodiments of the application can implement pruning of a reference frame for unidirectional prediction, thereby reducing calculation amount during coding, and increasing a coding speed.

It should be noted that an execution body of the reference frame processing method based on versatile video coding according to the embodiments of the application may be a client or a server, wherein the client may be specifically but not limited to various personal computers, notebook computers, smartphones, tablet computers, and portable wearable devices. The server may be specifically implemented by using an independent server or a server cluster including multiple servers. More specifically, the execution body may be an encoder.

The following describes the reference frame processing method based on versatile video coding by using several embodiments. For ease of understanding, the following provides descriptions by using an example in which the encoder is used as an execution body.

### Embodiment 1

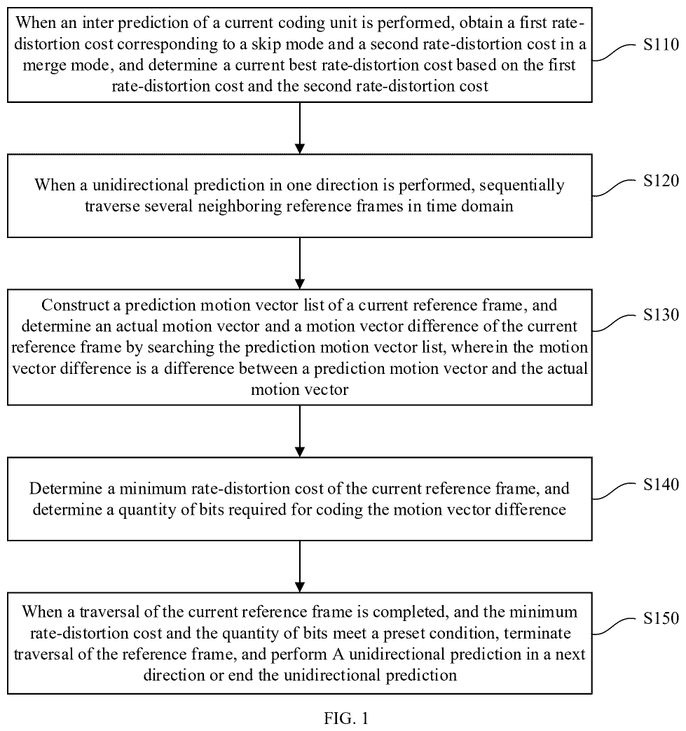

FIG. 1 is a schematic flowchart of a reference frame processing method based on versatile video coding according to Embodiment 1 of the application. The method may include step S110 to step S150. Specific descriptions are as follows:

Step S110: When an inter prediction of a current coding unit is performed, obtain a first rate-distortion cost in a skip mode and a second rate-distortion cost in a merge mode, and determine a current best rate-distortion cost based on the first rate-distortion cost and the second rate-distortion cost.

Specifically, when the inter prediction of the current coding unit is performed, predictions in the skip mode and the merge mode are first performed to determine the first rate-distortion cost corresponding to the skip mode and the second rate-distortion cost corresponding to the merge mode, and the first rate-distortion cost and the second rate-distortion cost are compared to take the smaller one as the current best rate-distortion cost.

Step S120: when a unidirectional prediction in one direction is performed, sequentially traverse several neighboring reference frames in time domain.

For example, assuming that there are 12 reference frames in the current coding unit including 6 reference frames in a forward direction and a backward direction respectively, if a forward unidirectional prediction is performed, 6 neighboring reference frames in a forward direction in time domain are sequentially traversed.

Step S130: Construct a prediction motion vector list of a current reference frame, and determine an actual motion vector and a motion vector difference of the current reference frame by searching the prediction motion vector list, wherein the motion vector difference is a difference between a prediction motion vector and the actual motion vector.

For example, assuming that the current reference frame is an i^{th} reference frame, when the i^{th} reference frame is traversed, a prediction motion vector list mvpᵢ of the i^{th} reference frame is constructed, and then an actual motion vector mvᵢ of the i^{th} reference frame is determined by searching the prediction motion vector list, thereby obtaining a motion vector difference mvdᵢ=mvpᵢ−mvᵢ.

Step S140: Determine a minimum rate-distortion cost of the current reference frame, and determine a quantity of bits required for coding the motion vector difference.

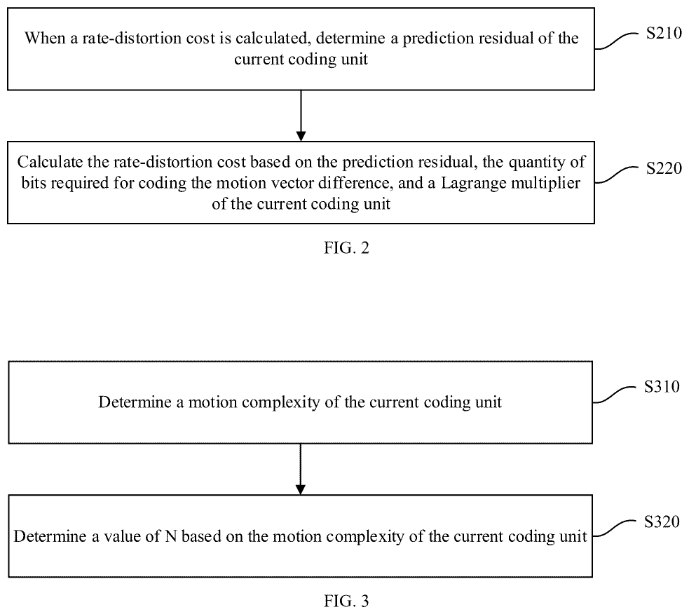

In an example embodiment, as shown in FIG. 2, the reference frame processing method based on versatile video coding in the embodiment of the application may further include step S210 and step S220.

Step S210: When a rate-distortion cost is calculated, determine a prediction residual of the current coding unit.

Step S220: Calculate the rate-distortion cost based on the prediction residual, the quantity of bits required for coding the motion vector difference, and a Lagrange multiplier of the current coding unit.

In the embodiment of the present application, the rate-distortion cost may be denoted as SATDCOST, and may be specifically calculated by using the following formula:

SATDCOST=SATD+λ*R.

Wherein SATD is a sum of absolute values of the prediction residual (a difference between a reference block pointed to by the motion vector and the current coding unit) after Hadamard transform is performed, R is the quantity of bits required for coding the motion vector difference, and λ is the Lagrange multiplier used by the coding unit.

It should be understood that the rate-distortion cost is calculated by using the foregoing formula, which has lower time overheads than an original rate-distortion cost, and can improve calculation efficiency to some extent.

Step S150: when a traversal of the current reference frame is completed, and the minimum rate-distortion cost and the quantity of bits meet a preset condition, terminate traversal of the reference frame, and perform a unidirectional prediction in a next direction or end the unidirectional prediction.

In an example embodiment, when the traversal of the current reference frame is completed, and the minimum rate-distortion cost of the current reference frame and the quantity of bits required for coding the motion vector difference do not meet the preset condition, a traversal of a next reference frame is continued. That is, when the preset condition is not met, the traversal of another reference frame in the direction is continued.

In an example embodiment, the preset condition may include: the minimum rate-distortion cost of the current reference frame is greater than N times a current best rate-distortion cost, and the current best rate-distortion cost is greater than M times a product of the quantity of bits required for coding the motion vector difference and a Lagrange multiplier used by the current coding unit, wherein N and M are greater than 1.

Specifically, values of N and M may be integers, decimals, or fractions.

The preset condition may be expressed as:

sᵢ>SP*Threshold₁&&Bitsᵢ*2*Threshold₂<SP; wherein

sᵢ is a minimum rate-distortion cost of an i^{th} reference frame, SP is the current best rate-distortion cost, Bitsᵢ is the quantity of bits required for coding the motion vector difference, and Threshold₁ and Threshold₂ represent N and M respectively.

It should be understood that, because different encoders may differ in implementation details, performance, optimization degree, and supported features, values of N and M may vary based on different encoders actually used. In addition, setting the current best rate-distortion cost to be greater than M times the product of the quantity of bits required for coding the motion vector difference and the Lagrange multiplier used by the current coding unit is intended to determine a relatively small quantity of bits, so that the value of M may be relatively large. For example, N may be 2, and M may be 20.

In a case that the minimum rate-distortion cost of the current reference frame and the quantity of bits required for coding the motion vector difference meet the preset condition, it indicates that searching in the direction is unlikely to have a better search result. Therefore, a calculation amount of coding can be reduced by terminating the traversal of the reference frame in the direction in advance, thereby implementing pruning of a remaining reference frame to be traversed in the direction, and improving coding efficiency and coding performance.

In an example embodiment, as shown in FIG. 3, the reference frame processing method based on versatile video coding according to an embodiment of the application may further include step S310 and step S320:

Step S310: Determine a motion complexity of the current coding unit.

The encoder may determine the motion complexity of the current coding unit based on a quantity of bits for coding the MVD. When the quantity of bits for the MVD is relatively large, it indicates that there is a relatively large difference between the motion vector prediction and the actual motion vector, which indicates that the motion complexity of the current coding unit is relatively high. On the contrary, when the quantity of bits for the MVD is relatively small, it indicates that there is a relatively small difference between the motion vector prediction and the actual motion vector, which indicates that the motion complexity of the current coding unit is relatively low.

Optionally, a model may be trained by using a machine learning method to identify the motion complexity of the coding unit. A size, a direction, and a rate of change of a motion vector of the current coding unit and a neighboring block of the current coding unit may be further analyzed. A relatively large motion vector, a rapidly changing direction, and inconsistent motion patterns generally indicate higher motion complexity.

Step S320: Determine a value of N based on the motion complexity of the current coding unit.

When the motion complexity is relatively high, the rate-distortion cost is generally relatively large, and when the motion complexity is relatively low, the rate-distortion cost is generally relatively small. Therefore, when the motion complexity is high, the value of N may be appropriately increased, and when the motion complexity is low, the value of N may be appropriately decreased, so that the value of N adapts to the motion complexity of the current coding unit, and accuracy of determining based on the preset condition is improved.

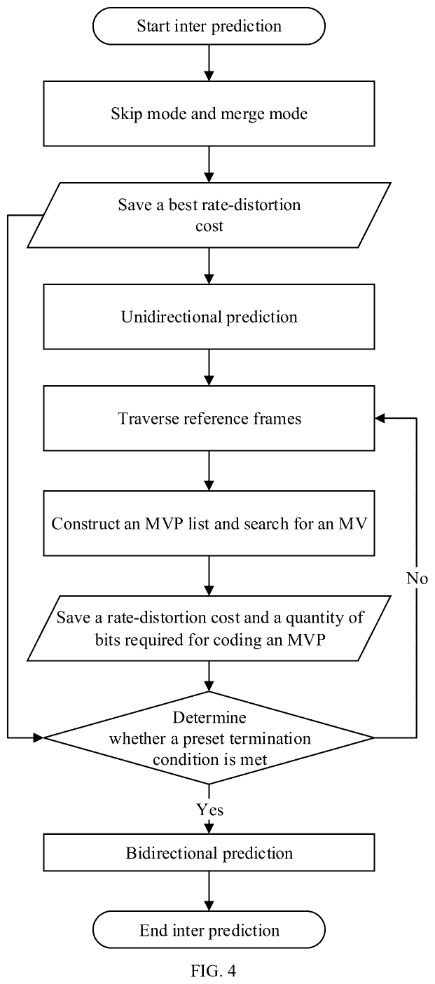

Referring to FIG. 4, FIG. 4 is a schematic flowchart of a reference frame processing method based on versatile video coding according to an embodiment of the application, and approximately may include the following process:
1. Start to perform the inter prediction.
2. Perform the predictions in the skip mode and the merge mode, calculate the rate-distortion costs in the two modes respectively, and obtain the current best rate-distortion cost based on the smaller one of the two rate-distortion costs.
3. Save the current best rate-distortion cost.
4. Perform the forward or backward unidirectional prediction.
5. Traverse reference frames based on a sequence in time domain, construct an MVP list for each reference frame traversal, then search the MVP list to determine an MV, and finally determine the minimum rate-distortion cost of the current reference frame and the quantity of bits required for coding a motion vector difference, wherein when the traversal of the current reference frame is completed, and the minimum rate-distortion cost of the current reference frame and the quantity of bits required for coding the vector difference meet the preset condition, the unidirectional prediction in the direction is terminated in advance; otherwise, the traversal of the next reference frame is continued.
6. When a forward and backward unidirectional prediction is completed, perform a bidirectional prediction, prune a reference frame for the bidirectional prediction by using a best reference frame for the unidirectional prediction, and finally select a best prediction manner based on the rate-distortion cost.

In the reference frame processing method based on versatile video coding according to the embodiment of the application, during inter prediction, firstly, the current best rate-distortion cost is determined based on rate-distortion costs corresponding to the skip mode and the merge mode, and then the unidirectional prediction in two directions is sequentially performed. During the unidirectional prediction, neighboring reference frames in time domain are sequentially traversed. During the traversal of the reference frame, the prediction motion vector list is constructed. The minimum rate-distortion cost of the current reference frame and the quantity of bits required for coding the motion vector difference are determined based on the prediction motion vector list. When the traversal of the current reference frame is completed, and the minimum rate-distortion cost of the current reference frame and the quantity of bits required for coding the motion vector difference meet the preset condition, the traversal of the reference frame is terminated, and the unidirectional prediction in the next direction is performed or the unidirectional prediction is ended. Pruning of the remaining reference frame to be traversed can be implemented, thereby implementing pruning of the reference frame for the unidirectional prediction, reducing the calculation amount during coding, and increasing the coding speed.

### Embodiment 2

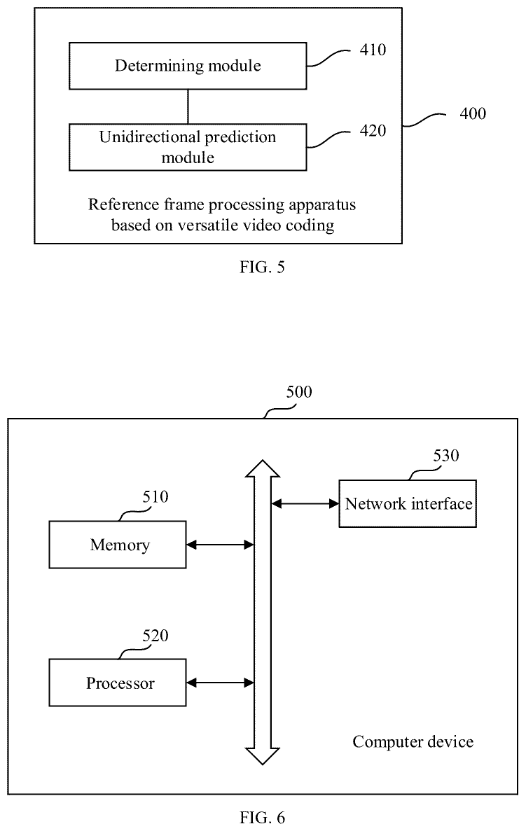

FIG. 5 is a schematic block diagram of a reference frame processing apparatus based on versatile video coding 400 according to Embodiment 2 of the application. The reference frame processing apparatus based on versatile video coding 400 may be divided into one or more program modules. The one or more program modules are stored in a storage medium and executed by one or more processors, to complete the embodiment of the application. The program module in the embodiment of the application is a series of computer program instruction segments that can be used to complete a specific function. The following specifically describes a function of each program module in the embodiment.

As shown in FIG. 5, the reference frame processing apparatus based on versatile video coding 400 may include a determining module 410 and a unidirectional prediction module 420.

The determining module 410 is configured to: when an inter prediction of a current coding unit is performed, obtain a first rate-distortion cost corresponding to a skip mode and a second rate-distortion cost in a merge mode, and determine a current best rate-distortion cost based on the first rate-distortion cost and the second rate-distortion cost.

The unidirectional prediction module 420 is configured to sequentially perform a unidirectional prediction in two directions, and sequentially traverse several neighboring reference frames in time domain when a unidirectional prediction in one direction is performed, wherein the following steps are performed during each reference frame traversal:
constructing a prediction motion vector list, and determining an actual motion vector and a motion vector difference of a current reference frame by searching the prediction motion vector list, wherein the motion vector difference is a difference between a prediction motion vector and the actual motion vector;
determining a minimum rate-distortion cost of the current reference frame, and determining a quantity of bits required for coding the motion vector difference; and
terminating traversal of the reference frame and performing unidirectional prediction in a next direction or ending unidirectional prediction when a traversal of the current reference frame is completed and the minimum rate-distortion cost and the quantity of bits meet a preset condition.

In an example embodiment, the unidirectional prediction module 420 is further configured to proceed to a traversal of a next reference frame when the traversal of the current reference frame is completed and the minimum rate-distortion cost and the quantity of bits do not meet the preset condition.

In an example embodiment, the preset condition includes: the minimum rate-distortion cost is greater than N times the current best rate-distortion cost, and the current best rate-distortion cost is greater than M times a product of the quantity of bits and a Lagrange multiplier used by the current coding unit, wherein N and M are greater than 1.

In an example embodiment, the unidirectional prediction module 420 is further configured to determine a motion complexity of a current coding unit and determine a value of N based on the motion complexity.

In an example embodiment the determining module 410 is further configured to determine a prediction residual of the current coding unit when a rate-distortion cost is calculated, and calculate the rate-distortion cost based on the prediction residual, the quantity of bits, and a Lagrange multiplier of the current coding unit.

### Embodiment 3

FIG. 6 is a schematic diagram of a hardware architecture of a computer device 500 applicable to the reference frame processing method based on versatile video coding according to Embodiment 3 of the application. The computer device 500 may be a device that can automatically calculate a value and/or process data based on instructions that are set or stored in advance. For example, the computer device may be a rack server, a blade server, a tower server, a cabinet server (including an independent server, or a server cluster including a plurality of servers), a gateway, or the like. As shown in FIG. 6, the computer device 500 includes but is not limited to at least a memory 510, a processor 520, and a network interface 530 that can be communicatively connected to one another by using a system bus.

The memory 510 includes at least one type of computer-readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 510 may be an internal storage module of the computer device 500, such as, a hard disk or a memory of the computer device 500. In some other embodiments, the memory 510 may be an external storage device of the computer device 500, such as, a plug-in type hard disk, a smart media card (SMC), a secure digital (SD) card, or a flash card that is disposed on the computer device 500. Certainly, the memory 510 may alternatively include both an internal storage module of the computer device 500 and an external storage device of the computer device 500. In the embodiment, the memory 510 is generally configured to store an operating system and various application software that are installed on the computer device 500, such as, program code of the reference frame processing method based on versatile video coding. In addition, the memory 510 may be further configured to temporarily store various types of data that have been output or are to be output.

In some embodiments, the processor 520 may be a central processing unit (CPU), a controller, a microcontroller, a microprocessor, or another data processing chip. The processor 520 is generally configured to control an overall operation of the computer device 500, for example, execute control and processing related to data interaction or communications performed by the computer device 500. In the embodiment, the processor 520 is configured to run program code stored in the memory 510 or process data.

The network interface 530 may include a wireless network interface or a wired network interface, and the network interface 530 is usually configured to establish a communication link between the computer device 500 and another computer device. For example, the network interface 530 is configured to connect the computer device 500 to an external terminal by using a network, and establish a data transmission channel, a communication link, and the like between the computer device 500 and the external terminal. The network may be a wireless or wired network, such as, an Intranet, the Internet, a global system for mobile communications (GSM), wideband code division multiple access (WCDMA), a 4G network, a 5G network, Bluetooth, or Wi-Fi.

It should be noted that FIG. 6 only shows a computer device that has a component 510 to a component 530. However, it should be understood that implementation of all the shown components is not required, and more or less components may alternatively be implemented.

In the embodiment, the reference frame processing method based on versatile video coding stored in the memory 510 may be further divided into one or more program modules to be executed by one or more processors (the processor 520 in the embodiment), to complete the embodiment of the application.

### Embodiment 4

An embodiment of the application further provides a computer-readable storage medium. The computer-readable storage medium stores a computer program. When the computer program is executed by a processor, the steps of the reference frame processing method based on versatile video coding in the embodiments are implemented.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or an internal memory of the computer device. In some other embodiments, the computer-readable storage medium may be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiment, the computer-readable storage medium is usually configured to store an operating system and various types of application software that are installed on the computer device, such as program code of the reference frame processing method based on versatile video coding in the embodiments. In addition, the computer-readable storage medium may be further configured to temporarily store various types of data that have been output or are to be output.

Clearly, a person skilled in the art should understand that the foregoing modules or steps in the embodiments of the application may be implemented by using a general computing apparatus. The modules or steps may be integrated into a single computing apparatus or distributed in a network including a plurality of computing apparatuses. Optionally, the modules or steps may be implemented by using program code that can be executed by the computing apparatus. Therefore, the modules or steps may be stored in a storage apparatus for execution by the computing apparatus. In addition, in some cases, the shown or described steps may be performed in an order different from the order herein. Alternatively, the modules or steps are separately made into integrated circuit module, or a plurality of modules or steps in the modules or steps are made into a single integrated circuit module for implementation. In this way, a combination of any specific hardware and software is not limited in the embodiments of the application.

The foregoing descriptions are merely preferred embodiments of the application, and are not intended to limit the scope of the application. Any equivalent structure or equivalent procedure change made based on the content of the specification and the accompanying drawings of the application is directly or indirectly applied to other related technical fields, and shall fall within the protection scope of the application.

What is claimed is:

1. A reference frame processing method based on versatile video coding, comprising:
when an inter prediction of a current coding unit is performed, obtaining a first rate-distortion cost in a skip mode and a second rate-distortion cost in a merge mode, and determining a current best rate-distortion cost based on the first rate-distortion cost and the second rate-distortion cost; and
performing a unidirectional prediction in two directions sequentially, and traversing several neighboring reference frames in time domain sequentially when a unidirectional prediction in one direction is performed, wherein the following steps are performed during each reference frame traversal:
constructing a prediction motion vector list, and determining an actual motion vector and a motion vector difference of a current reference frame by searching the prediction motion vector list, wherein the motion vector difference is a difference between a prediction motion vector and the actual motion vector;
determining a minimum rate-distortion cost of the current reference frame, and determining a quantity of bits required for coding the motion vector difference; and
terminating traversal of the reference frame and performing a unidirectional prediction in a next direction or ending the unidirectional prediction when a traversal of the current reference frame is completed and the minimum rate-distortion cost and the quantity of bits meet a preset condition.

2. The reference frame processing method based on versatile video coding according to claim 1, further comprising:
proceeding to a traversal of a next reference frame when the traversal of the current reference frame is completed and the minimum rate-distortion cost and the quantity of bits do not meet the preset condition.

3. The reference frame processing method based on versatile video coding according to claim 2, wherein the preset condition comprises:
the minimum rate-distortion cost is greater than N times the current best rate-distortion cost, and the current best rate-distortion cost is greater than M times a product of the quantity of bits and a Lagrange multiplier used by the current coding unit, wherein N and M are greater than 1.

4. The reference frame processing method based on versatile video coding according to claim 3, further comprising:
determining a motion complexity of the current coding unit; and
determining a value of N based on the motion complexity.

5. The reference frame processing method based on versatile video coding according to claim 1, further comprising:
determining a prediction residual of the current coding unit when a rate-distortion cost is calculated; and
calculating the rate-distortion cost based on the prediction residual, the quantity of bits, and a Lagrange multiplier of the current coding unit.

6. A reference frame processing apparatus based on versatile video coding, comprising:
a determining module, configured to: when an inter prediction of a current coding unit is performed, obtain a first rate-distortion cost in a skip mode and a second rate-distortion cost in a merge mode, and determine a current best rate-distortion cost based on the first rate-distortion cost and the second rate-distortion cost; and
a unidirectional prediction module, configured to sequentially perform a unidirectional prediction in two directions, and sequentially traverse several neighboring reference frames in time domain when a unidirectional prediction in one direction is performed, wherein the following steps are performed during each reference frame traversal:
constructing a prediction motion vector list, and determining an actual motion vector and a motion vector difference of a current reference frame by searching the prediction motion vector list, wherein the motion vector difference is a difference between a prediction motion vector and the actual motion vector;
determining a minimum rate-distortion cost of the current reference frame, and determining a quantity of bits required for coding the motion vector difference; and
terminating traversal of the reference frame and performing a unidirectional prediction in a next direction or ending the unidirectional prediction when a traversal of the current reference frame is completed and the minimum rate-distortion cost and the quantity of bits meet a preset condition.

7. The reference frame processing apparatus based on versatile video coding according to claim 6, wherein the unidirectional prediction module is further configured to:
proceed to a traversal of a next reference frame when the traversal of the current reference frame is completed and the minimum rate-distortion cost and the quantity of bits do not meet the preset condition.

8. The reference frame processing apparatus based on versatile video coding according to claim 7, wherein the preset condition comprises:
the minimum rate-distortion cost is greater than N times the current best rate-distortion cost, and the current best rate-distortion cost is greater than M times a product of the quantity of bits and a Lagrange multiplier used by the current coding unit, wherein N and M are greater than 1.

9. The reference frame processing apparatus based on versatile video coding according to claim 8, wherein the unidirectional prediction module is further configured to:
determining a motion complexity of the current coding unit; and
determining a value of N based on the motion complexity.

10. The reference frame processing apparatus based on versatile video coding according to claim 6, wherein the determining module is further configured to:
determining a prediction residual of the current coding unit when a rate-distortion cost is calculated; and
calculating the rate-distortion cost based on the prediction residual, the quantity of bits, and a Lagrange multiplier of the current coding unit.

11. A computer device, comprising a memory, a processor, and a computer program that is stored in the memory and capable of running on the processor, wherein when executing the computer program, the processor is configured to implement operations comprising:
when an inter prediction of a current coding unit is performed, obtaining a first rate-distortion cost in a skip mode and a second rate-distortion cost in a merge mode, and determining a current best rate-distortion cost based on the first rate-distortion cost and the second rate-distortion cost; and
performing a unidirectional prediction in two directions sequentially, and traversing several neighboring reference frames in time domain sequentially when a unidirectional prediction in one direction is performed, wherein the following steps are performed during each reference frame traversal:
constructing a prediction motion vector list, and determining an actual motion vector and a motion vector difference of a current reference frame by searching the prediction motion vector list, wherein the motion vector difference is a difference between a prediction motion vector and the actual motion vector;
determining a minimum rate-distortion cost of the current reference frame, and determining a quantity of bits required for coding the motion vector difference; and
terminating traversal of the reference frame and performing a unidirectional prediction in a next direction or ending the unidirectional prediction when a traversal of the current reference frame is completed and the minimum rate-distortion cost and the quantity of bits meet a preset condition.

12. The computer device according to claim 11, wherein the operations further comprise:
proceeding to a traversal of a next reference frame when the traversal of the current reference frame is completed and the minimum rate-distortion cost and the quantity of bits do not meet the preset condition.

13. The computer device according to claim 12, wherein the preset condition comprises:
the minimum rate-distortion cost is greater than N times the current best rate-distortion cost, and the current best rate-distortion cost is greater than M times a product of the quantity of bits and a Lagrange multiplier used by the current coding unit, wherein N and M are greater than 1.

14. The computer device according to claim 13, wherein the operations further comprise:
determining a motion complexity of the current coding unit; and
determining a value of N based on the motion complexity.

15. The computer device according to claim 11, wherein the operations further comprise:
determining a prediction residual of the current coding unit when a rate-distortion cost is calculated; and
calculating the rate-distortion cost based on the prediction residual, the quantity of bits, and a Lagrange multiplier of the current coding unit.

16. A non-transitory computer-readable storage medium, wherein the non-transitory computer-readable storage medium stores a computer program, and the computer program, when executed by at least one processor, causes the at least one processor to perform the reference frame processing method based on versatile video coding according to any one of claim 1.

17. The non-transitory computer-readable storage medium according to claim 16, wherein the at least one processor is caused to perform:
proceeding to a traversal of a next reference frame when the traversal of the current reference frame is completed and the minimum rate-distortion cost and the quantity of bits do not meet the preset condition.

18. The non-transitory computer-readable storage medium according to claim 17, wherein the preset condition comprises:
the minimum rate-distortion cost is greater than N times the current best rate-distortion cost, and the current best rate-distortion cost is greater than M times a product of the quantity of bits and a Lagrange multiplier used by the current coding unit, wherein N and M are greater than 1.

19. The non-transitory computer-readable storage medium according to claim 18, wherein the at least one processor is caused to perform:
determining a motion complexity of the current coding unit; and
determining a value of N based on the motion complexity.

20. The non-transitory computer-readable storage medium according to claim 16, wherein the at least one processor is caused to perform:
determining a prediction residual of the current coding unit when a rate-distortion cost is calculated; and
calculating the rate-distortion cost based on the prediction residual, the quantity of bits, and a Lagrange multiplier of the current coding unit.
